(19) United States
(12) Patent Application Publication
(10) Pub. No.: US 2023/0004130 A1
(43) Pub. Date: Jan. 5, 2023

(54) METHOD FOR OPTIMIZING PRODUCTION IN AN INDUSTRIAL FACILITY

(71) Applicant: Siemens Aktiengesellschaft, 8033 Müchen (DE)

(72) Inventors: ULRIKE DOWIE, Neubierg (DE); RALPH GROTHMANN, Rotenburg (DE); CHRISTIAN MARCEL KROISS, Müchen (DE); SIMONE HÜHN-SIMON, Erlangen (DE); ERIK SCHWULERA, Erlangen (DE); MATTHIAS SEEGER, Aschbach (DE); DIANNA YEE, Müchen (DE)

(73) Assignee: Siemens Aktiengesellschaft, 80333 Müchen (DE)

(21) Appl. No.: 17/785,347

(22) PCT Filed: Dec. 21, 2020
(86) PCT No.: PCT/EP2020/087463

§ 371 Date: Jun. 14, 2022

(30) Foreign Application Priority Data
Dec. 20, 2019 (EP) 19218452.1

(51) Int. Cl. G05B 13/02

(52) U.S. Cl. CPC G05B 13/0265

(57) ABSTRACT

A computer-Implemented method, system, and computer program product for optimizing production of an industrial facility. The industrial facility is designed to produce a predefinable quantity of at least one product. A model trained by machine learning is provided at a first time and the trained model is executed at a second time following the first time to generate a rolling forecast for a predefinable time interval. The predefinable time interval begins after the second time and the rolling forecast forecasts for any time within the time interval a quantity of the at least one product to be produced at this time. The rolling forecast is further processed by means of a further model to calculate a reforecast on the basis of the rolling forecast.

The Invention relates to a computer-implemented method for optimizing manufacturing in an industrial plant, wherein the industrial plant is configured to produce a specifiable quantity N_{P1}, N_{P2}, . . . N_{Pn} of at least one product P1, . . . Pn. Preferably, the industrial plant may produce a plurality of products or multiple product types according to quantity.

The invention additionally relates to a system for data processing, comprising means for carrying out such a method; a computer program, comprising commands which, when the program is executed by a computer, prompt said computer to carry out such a method and a computer-readable medium, comprising commands which, when executed by a computer, prompt said computer to carry out such a method.

The Invention moreover relates to a medium, for example a computer-readable storage medium or a data carrier signal.

For delivering customer orders on schedule, a sufficient availability of material and production capacity is of great importance. Due to the highly fluctuating customer requirements, which depend upon both time and quantity, overplanning may result in excess stock and underplanning may result in production standstills. This may lead to a loss of customer orders due to lacking the ability to supply, for example. For this reason, the supply chain aims for prediction accuracy which is as high as possible for future customer orders.

For corresponding predictions, it is possible to use expert systems, for example. In expert-based systems, as a general rule the customer representative or market expert is consulted and a prediction is provided on the basis of their assessment.

In today's industry 4.0 environment, there are frequent changes to customer behavior at short notice. The known systems, however, are unable to follow said customer behavior in a sufficiently rapid manner.

The object underlying the present invention is to improve the prediction accuracy under the aforementioned conditions and, as a result, to optimize the manufacturing in an industrial plant, for example a manufacturing plant.

The object is achieved according to the invention by a method cited in the introduction in that
a model trained by means of machine learning is provided at a first point in time;
the trained model is carried out at a second point in time which follows the first point in time t1, in order to generate a rolling forecast for a specifiable time interval, wherein the specifiable time interval begins after the second point in time and the rolling forecast predicts, for any given point in time within the time interval, a quantity of the at least one product to be produced at this point in time;
the rolling forecast is further processed by means of a further model, in order to calculate a re-forecast on the basis of the rolling forecast.

In one embodiment, at least one manufacturing parameter, for example quantity of material, grouping of staff etc. of the industrial plant can be adapted as a function of the calculated re-forecast.

The further processing of the rolling forecast by means of the further model has the advantage that the trained model has to be trained less often. It has been ascertained that the trained models are too slow to deliver good predictions for customer behaviors which act in a highly dynamic manner. Retraining the model is time-consuming and in most cases does not take place more often than once per quarter. Predictions which have been achieved using a trained model that is trained using the low frequency described above could be improved.

The further model, preferably a mathematically precise model which therefore can be carried out in a rapid manner—here also referred to as “post-processor”—takes into consideration the deviations of the rolling prediction calculated using the trained model from the observed reality and corrects the future forecast accordingly.

Through the use of the post-processor, it is possible to improve the prediction accuracy. The post-processor is able to use the deviations from the past and simultaneously the already existing customer requirements for the future, in order to minimize the future deviations.

In one embodiment, the post-processor (the further model) comprises multiple parameters, via which it is possible to set a deliberate overestimation or underestimation of the future orders, in particular those to be expected at short notice.

In one embodiment, it may advantageously be provided that the first trained model is based on at least one neural network and/or on at least one decision tree and/or on at least one linear model.

Moreover, it may be expedient if the further model is a preferably heuristic mathematical model and wherein, in order to calculate the re-forecast, actual values of the quantity to be produced and/or the actual number of orders and/or the actual orders on hand and/or at least one statistical variable calculated using at least one of the aforementioned values or at least one statistical parameter calculated using at least one of the aforementioned values is/are used.

Thus, both past values and future (predicted) values can be used for the re-forecast. It is possible to respond to changes at short notice in a more rapid manner and achieve a higher prediction accuracy as a result. This means that both short-term effects and medium-term trends can be identified.

Furthermore, the object is achieved according to the invention by an aforementioned medium, for example a computer-readable storage medium or a data carrier signal, in that the medium comprises at least one calculated re-forecast described as above.

The invention, together with further advantages, is explained in further detail below by way of exemplary embodiments which are illustrated in the drawing, in which:

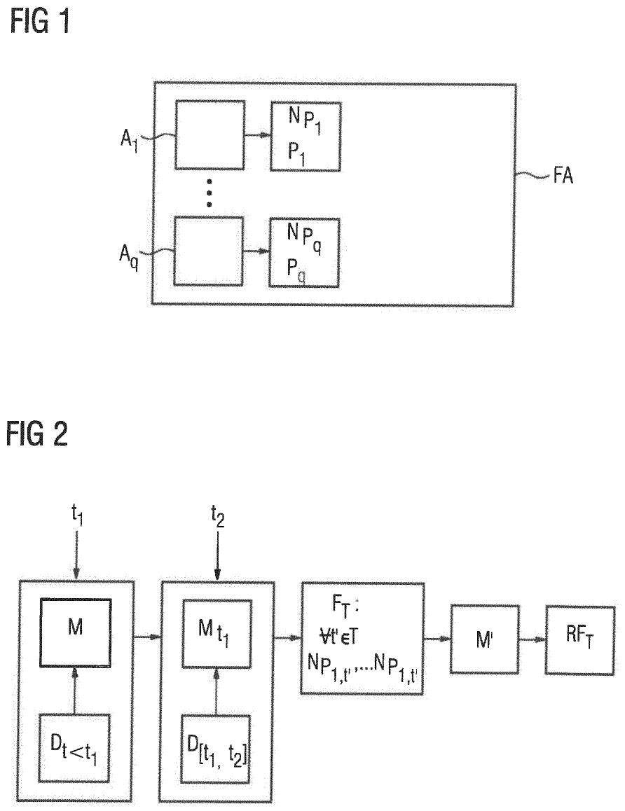

FIG. 1 shows an industrial plant, which is designed to produce multiple products;

FIG. 2 shows a flow diagram of a method, and

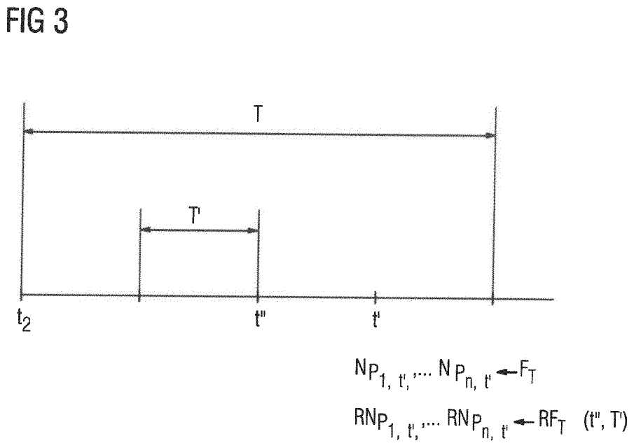

FIG. 3 shows a timeline for calculating a re-forecast.

FIG. 1 schematically shows an industrial manufacturing plant FA, for example an automated or autonomous manufacturing plant. The plant is capable of producing a certain number of products P1, . . . Pq, which for example may be commissioned by an order. In this context, products are understood to mean primarily material products—as opposed to services. For this purpose, the manufacturing plant FA may comprise manufacturing machines A1, . . . Aq, which each produce a certain product. It is by all means possible for a manufacturing machine to produce multiple different products. For example, it may be provided that a single manufacturing machine produces all products.

Each manufacturing machine, e.g. Ai, may be designed such that it is able to produce Nₚ; pieces of the product Pi within a certain time.

FIG. 2 shows an example of a method for optimizing manufacturing in a manufacturing plant FA. The optimization may be performed on the basis of historical data relating to the quantity N_{P1}, N_{P2}, . . . N_{Pn} of certain products P1, . . . Pn to be produced, wherein n is less than or equal to q, which the manufacturing plant is able to produce. Such historical data may, for example, retrospectively describe the customer behavior.

In the manufacturing plant FA, orders may be placed in which customers are able to request, for example, N_{Pk} pieces of product Pk at point in time tk, etc. The customer orders may be withdrawn, however, or the quantity to be produced, e.g. N_{Pk}, may be reduced or increased. In order to predict future customer behavior, it is possible for machine learning to be used.

In this context, a model Mₜ₁ trained by means of machine learning is provided at a first point in time t1. The trained model may, for example, be based on neural networks, decision trees, linear models or the like. In this context, the model M may have been trained on training data D_{t<t1} that was collected before the first point in time t1—i.e. which represents the historical customer behavior before the first point in time t1.

The trained model Mₜ₁ is carried out at a second point in time t2, which preferably lies after the first point in time t1 (t2≥t1), in order to generate a rolling forecast F_{T} for a specifiable time interval T. In this context, data that represents the customer behavior between t2 and t1 may be used as input data for the trained model Mₜ₁. It is by all means conceivable that t1=t2.

In this context, the specifiable time interval T begins after, preferably at the second point in time t2.

In order to cope with the customer behavior, which changes over time, the rolling forecast Fr predicts, for any given point in time t′ within the time interval T, quantities N_{P1,t′}, N_{P2,t′}, . . . N_{Pn,t′} of corresponding products P1, . . . Pn to be produced at this point in time t′ and/or the number of orders for products P1, . . . Pn. According to this prediction, parameters of the manufacturing plant FA are set. These parameters may, for example, be quantity of material and/or amount of staff available at a certain point in time.

It is understood that the orders contain manufacturing-relevant indications, for example regarding the quantity in which the respective product is to be produced, and regarding the time in which the respective product is to be produced, in particular regarding the point in time at which the respective product is to be delivered.

In order to improve the prediction accuracy in the event of customer requirements which fluctuate greatly and within a short time (for example, a third of orders may be canceled within a week), the rolling forecast F_{T} is further processed by means of a further model M′. In this context, a re-forecast RF_{T} is calculated on the basis of the rolling forecast F_{T}.

During the further processing of the rolling forecast F_{T}, it is possible to take into consideration further variables, which are already known. For example, in order to calculate the re-forecast RF_{T}, orders on hand and/or incoming orders etc. may be used.

If there is a desire to calculate the re-forecast RF_{T} at a point in time t′ within the time interval T, at which according to the rolling forecast F_{T} N_{P1,t′}, N_{P2,t′}, . . . N_{Pn,t′} pieces of products P1, . . . Pn are to be produced, it is possible to proceed as follows. One example of a corresponding timeline can be seen in FIG. 3.

For example, a further point in time t″ can be chosen between the start of the interval T and the point in time t′. The difference between t″ and t′ may be half a week to two weeks, preferably one week, for example. The difference between t″ and the start of the interval T, for example the second point in time t2, may amount to two to five weeks, in particular four weeks, for example.

The further model M′, which may be embodied as a (heuristic) mathematical model for example, in this context may be based on present data collected before the further point in time t″, wherein the data may represent the progression of the incoming orders and/or the orders on hand.

The mathematical model M′ may use deviations of a prediction according to the rolling forecast F_{T} from the development of orders actually observed and, in response to said deviations, create the re-forecast RF_{T}. In this context, deviations can be processed by means of different statistical functions. This simplifies the calculation of the further model′.

In particular, the quantity RN_{Pi,t′} of one of the products to be produced at the point in time t′, for example of the product Pi, can be calculated at the point in time t″ according to the following mathematical model M′:

$${RN}_{Pi , {t}^{′}} = max \{ {N}_{Pi , {t}^{′}} = {mean}_{{t}^{″} - {T}^{′} \leq t \leq {t}^{″}} ( {N}_{{PO}_{Pi , t}} - {N}_{{AO}_{Pi , t}} ) * {median}_{{t}^{″} - {T}^{′} \leq t \leq {t}^{″}} ( \frac{{AN}_{Pi , t}}{{N}_{{AO}_{Pi , t}}} ) , {ON}_{Pi , {t}^{′}} \} \qquad ( 1 )$$

In this context:

N_{Pi,t′}—quantity of the product Pi predicted according to the rolling forecast F_{T} and to be produced at the point in time t′;

$${mean}_{{t}^{″} - {T}^{′} \leq t \leq {t}^{″}}$$

an average value over a time interval T′ lying before the further point in time t″. Historical data from the time interval T′ is used to calculate the re-forecast RF_{T};

N_{PO}_{_{Pi,t}}—number of orders for product Pi predicted according to the rolling forecast F_{T} (predicted number of orders);

N_{AO}_{_{Pi,t}}- actual (actually observed) number of orders for product Pi (actual number of orders);

AN_{Pi,t}—actually commissioned quantity of the product Pi;

ON_{Pi,t′}—actual orders on hand (at point in time t″) for producing the product Pi at the point in time t′.

The time interval T′ may amount to two to five weeks, for example. In particular, the time interval T amounts to four weeks. Half a week to two weeks may lie between t″ and t′, for example. In particular, one week lies between t″ and t′.

Thus, statistical functions such as mean and/or median may be used in the model M′, in order to smooth out deviations of the rolling forecast F_{T} from the actually observed values.

The mathematical model M′ according to formula (1) produces the greater of two values. One of these values is the orders on hand ON_{Pi,t′} for the product Pi present at the point in time t″ and the point in time t′ which lies after the point in time t″ (FIG. 3). The second value represents a prediction corrected on the basis of deviations of the prediction according to the rolling forecast F_{T} from the development of orders actually observed.

It is now possible for manufacturing in the industrial plant to be adapted as a function of the calculated quantities RN_{Pi,t′}. For example, the quantity of material still required at the right time can be monitored and/or grouping of the corresponding staff can be adapted.

The further model M′ may further variables, for example request rate

$$\frac{{N}_{Pi , t}}{{N}_{{PO}_{Pi , t}}}$$

predicted according to the rolling forecast F_{T} for all Pi.

In summary, the invention relates to a method, in which manufacturing in a plant is optimized by increasing the prediction accuracy for the quantity of the respective products to be produced in future, wherein the increase in the prediction is achieved through the use of a model trained by means of machine learning and a further, preferably heuristic, simple mathematical model, which corrects the predictions of the trained model.

It is evident that alterations and/or additions of parts to the previously described optimization method may take place without deviating from the field and scope of the present invention. Likewise, it is evident that although the invention has been described in relation to specific examples, a person skilled in the art would certainly be in a position to obtain many other corresponding forms of an optimization method, which have the properties presented in the claims and thus all fall within the protective scope specified thereby.

The reference characters in the claims merely serve to better understand the present invention and do not in any case signify a restriction of the present invention.

1.-9. (canceled)

10. A computer-implemented method for optimizing manufacturing in an industrial plant configured to produce a specifiable quantity of at least one product with regard to a quantity of material, said method comprising:
providing at a first point in time a model trained by machine learning;
executing the trained model at a second point in time which follows the first point in time;
generating a rolling forecast for a specifiable time interval that begins after the second point in time;
predicting with the rolling forecast for any given point in time within the time interval a quantity of the at least one product to be produced at the given point in time;
further processing the rolling forecast by a further model;
calculating a reforecast based on the rolling forecast; and
automatically adapting at least one manufacturing parameter, comprising a quantity of material available, of the industrial plant as a function of the calculated reforecast.

11. The method of claim 10, wherein the model trained by machine learning is based on at least one neural network and/or on at least one decision tree and/or on at least one linear model.

12. The method of claim 10, wherein the further model is a heuristic mathematical model and, in order to calculate the reforecast, actual values of the quantity to be produced and/or a value of actual number of orders and/or a value of actual orders on hand and/or at least one statistical variable calculated using at least one of the aforementioned values or at least one statistical parameter calculated using at least one of the aforementioned values is/are used.

13. The method of claim 10, wherein the further model is a parameterized model, and comprises one or more parameters, via which it is possible to set a deliberate overestimation or underestimation of future orders.

14. A system for data processing, comprising a computer executing the method of claim 10.

15. A computer program product comprising a computer program embodied in a tangible non-transitory computer readable storage medium, comprising commands which, when the computer program is executed by a computer, causes said computer to execute the method of claim 10.

16. A computer-readable storage medium comprising at least one re-forecast calculated according to the method of claim 10.
